(19) United States
(12) Patent Application Publication
(10) Pub. No.: US 2019/0308280 A1
(43) Pub. Date: Oct. 10, 2019

(54) FILLER ADDITIVES TO AVOID WELD CRACKING

(71) Applicant: Siemens Energy, Inc., Orlando, FL (US)

(72) Inventor: Gerald J. Bruck, Pigeon Forge, TN (US)

(21) Appl. No.: 15/945,075

(22) Filed: Apr. 4, 2018

(51) Int. Cl. B23K 35/02; B33Y 70/00; B23K 35/30; B23K 35/32; B23K 1/005; B23K 35/26; B23K 35/28

(52) U.S. Cl. CPC B23K 35/0255; B33Y 70/00; B23K 35/0222; B23K 35/3033; B23K 35/3046; B23K 35/282; B23K 35/325; B23K 1/0056; B23K 35/266; B23K 35/286; B23K 35/284; B23K 35/3053

(57) ABSTRACT

There is provided a feed material, wherein the feed material has an elongated body that includes an amount of an alloy filler material and an amount of one or more elemental metal additives effective to scavenge at least one tramp element upon melting of the feed material.

### FIELD

The present invention relates to the field of metallurgy, and more specifically to compositions and processes for removing tramp elements that contribute to defects during a high temperature deposition process, e.g., a joining, repair, or an additive manufacturing process.

### BACKGROUND

By way of example, weld metal solidification cracking (also known as hot cracking, liquation cracking, and microfissuring) is often caused during welding repair of defects in superalloy components. Oftentimes, last to solidify portions of the melt have grain boundaries that are still wet from low melting point eutectic compositions. These low melting point eutectic compositions may be formed by tramp elements, which refer to contaminants that are present in an alloy at relatively low concentrations. Tramp elements may be found alone or in combination with other constituents including silicon, carbon, oxygen, and nitrogen in the melt or resulting weld. The abovementioned grain boundaries (weakened by tramp elements) are often pulled apart by opposed shrinkage of the deposit laterally from the sides of the excavation, thereby resulting in cracking. Even when cracking is not produced, residual stresses remain after welding. Such residual stresses add to stresses resulting from post-process heat treatment, producing what is commonly referred to as strain age cracking or reheat cracking. Deposition processes, e.g., welding processes as discussed, would benefit from the selective removal of such tramp elements from the melt pool prior to solidification. Accordingly, there is a need for improved methods and materials for removing elements that contribute to defects during a deposition process.

### BRIEF DESCRIPTION OF THE DRAWINGS

The invention is explained in the following description in view of the drawings that show:

FIG. 1 illustrates a cored wire having a weld filler alloy and one or more tramp element scavenging additives in accordance with an aspect of the present invention.

FIG. 2 illustrates a coated wire having a weld filler alloy and one or more tramp element scavenging additives in accordance with an aspect of the present invention.

FIG. 3 illustrates the use of a feed material as described herein in a deposition process to reduce or eliminate an amount of tramp elements in a melt pool (and resulting cladding) in accordance with an aspect of the present invention.

### SUMMARY

The present inventor has developed materials and processes for removing tramp elements that contribute to weld defects by incorporating one or more elemental metal additives (scavengers) into an alloy filler material utilized in a deposition process. The one or more elemental metal additives selectively remove one or more tramp elements from a melt pool (resulting from the melting of the alloy filler material, underlying substrate surface, and additive(s)) during the deposition process. In an aspect, the one or more elemental metal additives are mixed or otherwise combined with an alloy filler material in a weld feed material (hereinafter “feed material”), such a cored filler wire, coated wire, coated strip, cored filler strip, or the like. In this way, the feed material provides the necessary material for the deposition process, as well as provides one or more additives that eliminate or reduce defects in the resulting deposit. In another aspect, the additives form a byproduct with the tramp element(s) which is easily removed from the melt pool as a gas, solids layer, or the like.

In view of the above and in accordance with an aspect of the present invention, there is provided a feed material comprising an amount of an alloy filler material and an amount of one or more elemental metal additives effective to remove at least one tramp element upon melting of the feed material and adjoining substrate surface.

In accordance with another aspect, there is provided a method for reducing tramp elements that contribute to weld cracking during a deposition process, the method comprising:

introducing a feed material adjacent a surface of an alloy substrate, wherein the feed material comprises an alloy filler material and an amount of one or more elemental metal additives effective to scavenge at least one tramp element upon melting of the feed material;

melting the feed material and a portion of the adjacent substrate surface to form a melt pool of the feed material;

reacting the one or more elemental metal additives with one or more tramp elements to form a reaction product;

removing the reaction product from the melt pool; and cooling the melt pool to form a desired deposit on the substrate.

### DETAILED DESCRIPTION

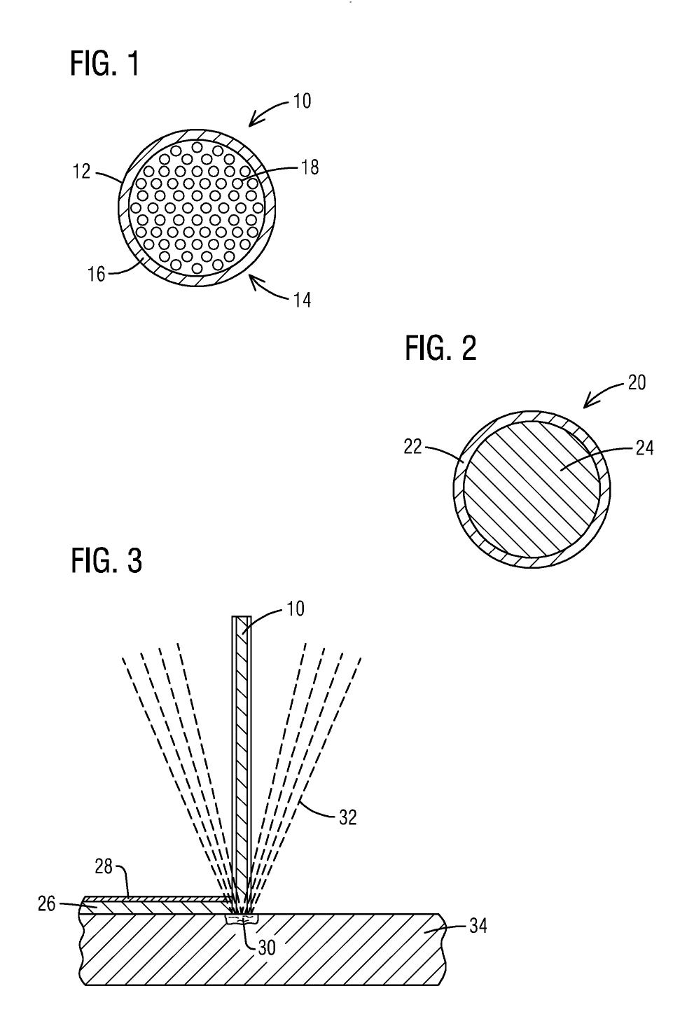

Now referring to the figures, FIG. 1 illustrates an embodiment of a feed material 10 for a high temperature deposition process (e.g., a joining, repair, or an additive manufacturing process) in accordance with an aspect of the present invention. In FIG. 1, the feed material 10 comprises an elongated body 12 comprising an amount of an alloy filler material and an amount of one or more elemental metal additives effective to scavenge at least one tramp element upon melting of the feed material 10. In certain embodiments, the alloy filler material and the one or more elemental metal additives may be mixed together. In other embodiments, the alloy filler material and one or more elemental metal additives may be separated from one another in the feed material 10.

In the embodiment of FIG. 1, the feed material 10 is in the form of a cored wire 14. As shown, the cored wire 14 comprises an outer shell or casing 16 surrounding an inner portion of the wire which houses a powder material 18 that comprises at least the alloy filler material. In an embodiment, the powder material 18 comprises a mixture of the alloy filler material and the one or more elemental metal additives. In other embodiments, the powder material 18 comprises the alloy filler material and the outer shell 16 comprises the one or more elemental metal additives.

In another embodiment, as shown in FIG. 2, the feed material 10 may comprise a coated wire 20. The coated wire 20 comprises an outer coating 22 which overlays an interior continuous (non-powdered) body 24 of a material, such as a metal alloy material. In certain embodiments, the coating 22 consists of the one or more elemental metal additives while the body consists of the alloy filler material. In other embodiments, the coating 22 or body 24 comprises a mixture of the alloy filler material and the one or more elemental metal additives. In still further embodiments, the weld material may be in the form of a strip, which may have a similar filled core as the cored wire 14 or may be coated similar to wire 20. Comparatively, the strip may have a much wider and flatter (e.g., more rectangular) profile relative to the cored wire 14 or coated wire 20.

The alloy filler material of feed material 10 may comprise any suitable alloy material for use in joining one substrate to another, for repair of a substrate, and/or for an additive manufacturing process. When applying the alloy material to an existing substrate, the alloy filler material may have a composition which matches or is substantially similar to the substrate. Without limitation, the alloy filler material may comprise a nickel-based alloy material, a nickel-chromium based alloy, a stainless steel material, a cobalt-based alloy, an iron-based alloy, and a titanium-based alloy. In certain embodiments, the substrate may comprise an identical or substantially similar composition to the alloy filler material. In an aspect, known superalloys that are used for high temperature applications such as gas turbine engines may be joined, repaired or coated with the inventive processes and feed materials 10. In certain embodiments, as with the cored wire 14, the alloy filler material may be in the form of a powder. The powder may have any suitable particle size such as from 0.01 micron to 5 micron. In other embodiments, the alloy filler material may be in the form of a coating, e.g., coating 22, or a continuous body (e.g., body 24) of the material.

The one or more elemental metal additives for the feed material 10 comprise any one or more elements (provided by any suitable form) which are effective to scavenge or remove one or more tramp elements from a melt pool formed from melting of at least the feed material. In certain embodiments, at least a portion of the substrate is also melted to contribute to the melt pool. In the case of an additive manufacturing process, a portion of the previously deposited (and solidified) layer may be melted to contribute to the melt pool.

The tramp elements may comprise any element(s) which are undesired and believed to at least contribute to one or more defects in the resulting weld if not removed. Without limitation, the tramp elements may comprise one or more of arsenic, antimony, bismuth, boron, lead, sulfur, phosphorous, and combinations thereof. Correspondingly, the one or more elemental metal additives may comprise any suitable material which will remove the one or more tramp elements by forming one or more reaction products therewith. In an embodiment, the one or more reaction products is in the form of a solid. In other embodiments, the one or more reaction products is in the form of a gas.

In an embodiment, the additive may comprise a member selected from the group consisting of aluminum, cadmium, calcium, magnesium, titanium, zinc, zirconium, and combinations thereof. In some embodiments, the one or more additives are alloyed with one or more further metals, such as nickel. In a particular embodiment, the additive comprises a nickel-titanium alloy, for example. As with the alloy filler material, the one or more elemental metal additives may be provided in any suitable form and in amount effective to remove the one or more tramp elements. In an embodiment, the one or more elemental additives are provided in powder form, as a coating, or in any other suitable solid form.

In a particular embodiment, the one or more additives comprise aluminum, which may be in the form of an aluminum coating or a powder constituent, and which typically also will further include surface oxides of alumina (Al₂O₃). The aluminum and/or alumina reacts with a tramp element (such as sulfur), or alternatively under conditions of melting dissociates into an amount of elemental Al to react with the sulfur. In either case, the alumina or alumina is effective to scavenge a tramp element (such as sulfur) from the melt pool. An exemplary equation for such a reaction is:

2Al+6O₂+3S→Al₂(SO₄)₃

In this instance, the resulting product, aluminate sulfate, is a low density white crystalline material which will have a lower density relative to most alloys, and thus is likely to float to the melt pool surface and solidify as a readily removable solid layer. In addition, of benefit and as shown, the conversion to aluminum sulfate requires oxygen, which reduces the need to produce an oxygen free environment during a welding process. In certain embodiments, a partially oxidizing shielding gas, including for example oxygen or carbon dioxide, may be of benefit to enhance the desired reaction(s).

In an embodiment, the aluminum is added to powder alloy filler material, and is provided as a cored wire 14 as shown. In another embodiment, the aluminum may be provided as a coating 22 on a coated wire 20 of alloy filler material as described above. When provided as a coating 22, the aluminum may comprise any suitable thickness. To determine the necessary or desired thickness, several factors may be taken into consideration. For example, the Al coating should be sufficiently thick to:

a) compensate for any volatilization of aluminum during processing;

b) react with an expected amount of the targeted tramp elements (e.g., sulfur) in the melt pool; and

c) be sufficient to provide or otherwise contribute to the minimum and maximum allowable Al ranges for the weld or final deposit.

In another particular embodiment, the additive may comprise an amount of zinc effective to reduce or eliminate an amount of one or more tramp elements in the melt pool. In an embodiment, the zinc may react with sulfur and phosphorous according to the reactions to form a removable reaction product from the melt pool:

Zn+2O₂+S→Zn(SO₄)

3Zn+4O₂+2P→Zn₃(PO₄)₂

The zinc thus may be provided in an amount effective to scavenge sulfur, phosphorous, or any other tramp element which forms a product with zinc. Preferably, care is taken such that little if any zinc remains from the melt pool (after removal of the zinc reaction product with the tramp element). In an embodiment, the zinc is provided as a coating 22 on the coated wire 20, or alternatively as all or part of casing 16 of the cored wire 14 as described above in an amount effective to reduce or eliminate one or more tramp elements from a melt pool of the material 10.

In still other embodiments, the additive may comprise elemental cadmium, calcium, magnesium, titanium, or zirconium (along with inevitable surface oxides of these metals) in an amount effective to reduce or eliminate one or more tramp elements from the melt pool. By way of example, to reduce or remove an amount of sulfur or phosphorous, the one or more additives may comprise an effective amount of cadmium, calcium, magnesium, and combinations thereof. In yet a further embodiment, the one or more additives may comprise an effective amount of titanium, zirconium, and magnesium effective to react with an amount of boron in the melt pool in order to reduce or eliminate an amount of boron. In still another embodiment, the additive may comprise one or more materials effective to form a removable reaction product with arsenic, antimony, phosphorous, tin, and combinations thereof during a deposition process. The latter embodiment may be particularly useful for use in reducing or preventing embrittlement in Cr—Mo-alloyed steels, for example. In certain embodiments, the feed material 10 may be fed with shielding gases or any other suitable material for providing an inert or partially oxidizing environment.

In accordance with another aspect of the present invention, there is provided a method for reducing a presence of tramp elements during a deposition process using the feed materials 10 described above. By way of example, the deposition process may be one of a joining, repair, or additive manufacturing process. It should be appreciated that any method steps disclosed herein are not required to be performed in any particular order, and are hereby provided for exemplary purposes.

Referring now to FIG. 3, in an embodiment, the method comprises melting the feed material 10 and a portion of the associated substrate 34 to form a melt (weld) pool 30 comprising molten feed material via a suitable energy source (not shown). The energy source may comprise any suitable source for delivering a suitable amount of energy for the melting. In an embodiment, the energy source is one configured for melting by energy beam directed energy. For example, in an embodiment, the energy source comprises a laser energy source. In such case, the laser source is operably configured to emit laser energy, e.g., a laser beam 32 (continuous and/or pulsed), therefrom and towards the substrate 34 for melting portions of at least the feed material 10 to form layers of the additive (build-up) materials 26 thereon upon solidification of the melted portions. As needed, each deposited layer of feed material 10 is allowed to cool and solidify to form the desired deposited material. In still other embodiments, the energy source is one that allows for melting by arc directed energy.

Within the melt pool 30, it is appreciated that the one or more elemental metal additives will react with any tramp elements therein as set forth above to form one or more reaction products. The tramp elements may originate from the substrate 34 or alloy filler material, for example. In certain embodiments, for example, an amount of phosphorous and sulfur may be scavenged from the melt pool 30 by the one or more elemental metal additives by formation of a suitable reaction product thereof. The process also includes removing the reaction product(s) produced by the one or more elemental metal additives and the one or more tramp elements by any suitable process. In an embodiment, the one or more reaction products form a solid which has a lower density than that of the material in the melt pool 30. As such, the reaction product may float or other dissociate to a top portion of the melt pool 30 where it may be removed by any suitable process or system. In an embodiment, as shown in FIG. 3, each deposition layer (formed via melting of feed material 10) results in a cladding 26 and a solid waste layer 28 comprising a reaction product between the one or more elemental metal additives and the one or more tramp elements. In other embodiments, the one or more reaction products may be in the form of a gaseous waste which travels or is otherwise carried away from the substrate (by a sweeping gas or the like).

It is appreciated that any suitable energy source (laser, arc, plasma, electron beam) or deposition technique may be utilized to melt the feed material 10 to form the desired deposit. In an embodiment, the energy source may include a feed tool (not shown) operably connected to the energy source or approximately thereto, for feeding and/or depositing the feed material 10 towards the substrate 34 and/or into the melt pool for processing. The tool may be operatively connected to the energy source and/or a controller for controlling the deposition or feeding of the feed material 10 into the melted portions of the base material. The controller may also be operably configured to control the intensity (heat temperature) of the energy and feed rate of the feed material 10.

In certain embodiments, the method may include preparing the substrate 34 for the deposition process. For example, when the substrate 34 comprises an existing component in need of repair, preparing the substrate 34 may include removing the component (damaged or otherwise) from an industrial machine, e.g., a turbomachine engine, removing any damaged portions from the component, and pre-heating and/or solution treating the component prior to beginning the deposition process. The damaged portions may be removed by grinding, milling, or other means for removing damaged portions of a superalloy component known in the art. Upon removing any undesired portions from the component, the component may be placed or removably secured to, e.g., a platform (not shown) or other type of securing means in, e.g., a chamber or other defined work area, for joining, build-up and/or repair using the feed material 10.

In certain embodiments, the melt pool 34 may be protected by a shielding gas, e.g., argon, helium or mixtures thereof, which may be applied via the energy source or a shielding system operably connected thereto for protecting the melt pool and/or deposit from contaminants or atmospheric reactions except as required to enhance tramp element reaction products. In an embodiment, the feed material 10 may be repeatedly deposited on a previously deposited layer until a shape and/or geometry of a desired component is achieved. It should be appreciated that a full metallurgical bonding and a self-healing of solidification cracks (hot cracks) during the process may also be achieved in a post weld heat treatment process such as by hot isostatic pressing.

Once the desired finished product has been achieved via the feed material 10, the method may include steps for finishing the desired component, which may include machining or otherwise removing any undesired waste remaining from the process, and commencing any post weld treatments, e.g., post heat or solution treatment, prior to providing the component for operation in, e.g., an industrial machine.

In addition, it is appreciated that the process steps disclosed herein may be implemented by any appropriate processor system using any appropriate programming language or programming technique. The processor system can take the form of any appropriate circuitry, such as may involve a hardware embodiment, a software embodiment or an embodiment comprising both hardware and software elements. In one embodiment, the system may be implemented by way of software and hardware (e.g., processor, sensors, etc.), which may include but is not limited to firmware, resident software, microcode, etc.

Furthermore, parts of the processor system can take the form of a computer program product accessible from a processor-usable or processor-readable medium providing program code for use by or in connection with a processor or any instruction execution system. Examples of processor-readable media may include non-transitory tangible processor-readable media, such as a semiconductor or solid-state memory, magnetic tape, a removable computer diskette, a random access memory (RAM), a read-only memory (ROM), a rigid magnetic disk and an optical disk. Current examples of optical disks include compact disk--read only memory (CD-ROM), compact disk-read/write (CD-R/W) and DVD.

While various embodiments of the present invention have been shown and described herein, it will be obvious that such embodiments are provided by way of example only. Numerous variations, changes, and substitutions may be made without departing from the invention herein. Accordingly, it is intended that the invention be limited only by the spirit and scope of the appended claims.

The invention claimed is:

1. A welding feed material comprising:
an alloy filler material and an amount of one or more elemental metal additives effective to scavenge at least one tramp element upon melting of the welding feed material.

2. The welding feed material of claim 1, wherein the welding feed material comprises a powder cored filled wire or strip.

3. The welding feed material of claim 2, wherein the powder cored filled wire or strip comprises an outer shell surrounding an inner core of a powder material, and wherein the inner core of powder material comprises at least the alloy filler material.

4. The welding feed material of claim 3, wherein the inner core consists of the alloy filler material and the outer shell consists of the one or more elemental metal additives.

5. The welding feed material of claim 3, wherein the inner core comprises a powder mixture of the alloy filler material and the one or more elemental metal additives.

6. The welding feed material of claim 1, wherein welding feed material comprises a coated wire or strip, and wherein the one or more elemental metal additives are present as a coating on an elongated body of the wire or strip.

7. The welding feed material of claim 1, wherein the alloy filler material comprises a member selected from the group consisting of a nickel-based superalloy material, a stainless steel material, a cobalt-based alloy, an iron-based alloy, and a titanium-based alloy.

8. The welding feed material of claim 1, wherein the one or more elemental metal additives comprise a member selected from the group consisting of aluminum, calcium, cadmium, magnesium, titanium, zinc, zirconium, and combinations thereof.

9. The welding feed material of claim 1, wherein the one or more tramp elements comprise a member selected from the group consisting of arsenic, antimony, bismuth, boron, lead, sulfur, phosphorous, and combinations thereof.

10. A method for reducing tramp elements that contribute to weld cracking during a deposition process, the method comprising:
introducing a feed material adjacent a surface of an alloy substrate, wherein the feed material comprises an alloy filler material and an amount of one or more elemental metal additives effective to scavenge at least one tramp element upon melting of the feed material;
melting the feed material and a portion of the adjacent substrate surface to form a melt pool of the feed material;
reacting the one or more elemental metal additives with one or more tramp elements to form a reaction product;
removing the reaction product from the melt pool; and
cooling the melt pool to form a desired deposit on the substrate.

11. The method of claim 10, wherein the welding feed material comprises a powder cored filled wire or strip.

12. The method of claim 11, wherein the powder cored filled wire or strip comprises an outer shell surrounding an inner core of a powder material, and wherein the inner core of powder material comprises at least the alloy filler material.

13. The method of claim 12, wherein the inner core consists of the alloy filler material and the outer shell consists of the one or more elemental metal additives.

14. The method of claim 10, wherein welding feed material comprises a coated wire or strip, and wherein the one or more elemental metal additives are present as a coating on an elongated body of the wire or strip.

15. The method of claim 10, wherein the alloy filler material comprises a member selected from the group consisting of a nickel-based superalloy material, a stainless steel material, a cobalt-based alloy, an iron-based alloy, and a titanium-based alloy.

16. The method of claim 10, wherein the one or more elemental metal additives comprise a member selected from the group consisting of aluminum, cadmium, calcium, magnesium, titanium, zinc, zirconium, and combinations thereof.

17. The method of claim 10, wherein the one or more tramp elements comprise a member selected from the group consisting of arsenic, antimony, bismuth, boron, lead, sulfur, phosphorous, and combinations thereof.

18. The method of claim 10, wherein the melting is done by energy beam emission directed energy.

19. The method of claim 10, wherein the melting is done by arc directed energy.

20. The method of claim 10, further comprising introducing a shielding gas along with the feed material for providing an inert or oxidizing environment for the reacting of the one or more elemental metal additives with the one or more tramp elements.
